(19) United States
(12) Patent Application Publication
(10) Pub. No.: US 2004/0177128 A1
(43) Pub. Date: Sep. 9, 2004

(54) Streamlined portable data exchange device and method

(76) Inventor: David C. Northway, San Carlos, CA (US)

Correspondence Address: WEIDE & MILLER, LTD., 7251 W. LAKE MEAD BLVD., SUITE 530, LAS VEGAS, NV, 89128, US

(21) Appl. No.: 10/769,400

(22) Filed: Jan. 30, 2004

Related U.S. Application Data
(60) Provisional application No. 60/445,332, filed on Feb. 5, 2003.

(51) Int. Cl. G06F 15/16

(52) U.S. Cl. 709/217

(57) ABSTRACT

A portable data exchange device is configured to load a primary data set and store that data set in a first data location. The portable data exchange device may transmit or send that primary data set to one or more remote devices via a wireless communication interface. The portable data exchange device is configured to receive one or more secondary data sets from one more remote devices, and to store those secondary data sets in a second data location. In one embodiment, the device is battery powered and data is transmitted and received via an infrared transceiver. The device includes an operator selector, the selector permitting the operator to initiate an operation of the device. In one embodiment, the selector is a single button. An indicator comprising other than a graphical display provide information regarding the outcome of an operation.

### RELATED PATENT APPLICATION

The application is a non-provisional patent application claiming priority to Provisional Patent Application Serial No. 60/445,332, filed Feb. 5, 2003.

### FIELD OF THE INVENTION

The present invention relates to mobile, wireless computer systems and more specifically to a system and method for transmitting and receiving electronic data files.

### BACKGROUND OF THE INVENTION

As continuing advances in technology have enabled the further miniaturization of the components required to build computer systems, a variety of methods and systems have been developed over time to allow the storage, transmission, reception, and collection of electronic data. Current systems with this functionality, however, tend to be bulky, expensive, and complex and slow in their use, and are focused on storing large amounts of electronic data and often performance of a variety of additional functions. Further, current systems for electronic file storage and communication typically require an alphanumeric display to navigate and select files for manipulation by an operator.

One example of a product currently used to store, transfer, receive and collect electronic data is a data storage disk, typically referred to as a floppy disk. People often use these disks to store electronic data and/or transfer electronic data between computer systems. One drawback of current electronic disk based storage systems is that they do not allow for communication and sharing of stored electronic data themselves, but must rely on a separate physical disk drive reader, typically referred to as a floppy drive, which is typically installed in a computer system, in order to read, load, and transfer electronic data stored on the electronic data disk.

Another type of electronic storage system relies on solid-state memory, typically constructed using a non-volatile random access memory component. These solid-state memory storage systems are typically referred to as memory cards. As with electronic data disks, memory cards also offer no means to read, load, and transfer information stored on the memory card itself without the use of a physical memory card reader attached to a host computer system.

Still another type of computer storage system able to store and share electronic data is a personal digital assistant computing device, referred to as a PDA. One drawback of PDA computer systems is that they are often too expensive and bulky to carry with an operator regularly and are often complex in their operation and slow to use, requiring an alphanumeric display with multiple operator screens and menu selections to successfully to store, send, receive and transfer electronic data wirelessly. The additional components, features, cost, and complexity of PDA's and other computer systems with graphical or alphanumeric displays make them bulky for an operator to have the device with them at all times, hampering the effectiveness and ability to store, collect, and transfer electronic data at any time, in any location, with other computer devices, systems, networks, and operators. Another drawback is that the power requirements of a PDA computing system or other miniature computing systems using a dedicated graphical/alphanumeric displays do not afford the economy, power savings or size reduction possible in a system without such an integrated display. The power requirements of such devices are further heightened because the devices include a large number of components for implementing the “multi-function” configuration of the devices.

### SUMMARY OF THE INVENTION

The present invention is a portable data exchange device.

In one physical implementation of the device, the device includes an enclosure which houses or supports various components of the device. The enclosure defines an interior area which houses components of an operational system.

In one embodiment, a control system includes at least one data storage device or memory, a processor, and a wireless communication interface. A bus or other communication interface permits data to be exchanged between the components.

The device includes at least one selector. The selector accepts input from an operator. Input to the selector initiates one or more functions or operations. In one embodiment, the selector is a single button. When the button is a push-button, various functions may be initiated depending on an interval of time the button is depressed. When the button is a sliding button, various functions may be initiated depending on the position of the button.

The device includes at least one indicator. In one embodiment, the indicator comprises at least one light. The indicator may also comprise or include a tone generator. The indicator is used to transmit information to the operator regarding the outcome of an operation.

The device is preferably configured to implement various functions or operations. In one operation, the device is configured to load a primary data set and store that data set in a first data location. In another operation, the primary data set may be transmitted or sent to one or more remote devices, such as via the wireless communication interface. In yet another operation, the device is configured to receive one or more secondary data sets from one more remote devices, and to store those secondary data sets in a second data location.

The device is preferably uniquely configured to accomplish these functions. The device utilizes a low power infrared wireless transceiver and is small in size. The device is battery powered. At least one attachment point is associated with the enclosure, permitting the device to be connected to other items, such as a key ring.

The device has numerous advantages, including greatly simplifying the process of exchanging personal data such as “business card” information with others. The device does not include a complex and power consuming graphical or alpha-numeric display, and has a simplified user input and feedback configuration.

Further objects, features, and advantages of the present invention over the prior art will become apparent from the detailed description of the drawings which follows, when considered with the attached figures.

### DESCRIPTION OF THE DRAWINGS

FIG. 1A is a perspective topside view of one embodiment of a device for transmitting and receiving electronic data files, according to the invention;

FIG. 1B is a perspective topside view of the device of FIG. 1A with a battery holder in the open position, according to the invention;

FIG. 2A is an exploded topside assembly view of the device of FIG. 1A, according to the invention;

FIG. 2B is an exploded bottom side assembly view of the device of FIG. 1A, according to the invention;

FIG. 3A is one embodiment of an operator interface of the device of the invention;

FIG. 3B is yet another embodiment of an operator interface of the device of the invention;

FIG. 3C is yet another embodiment of an operator interface of the device of the invention;

FIG. 4A is one embodiment of an enclosure of the device of the invention;

FIG. 4B is the enclosure of FIG. 4A in the open state, according to the invention;

FIG. 5A is a functional block diagram illustrating one embodiment of a control system operational system of the device of the invention;

FIG. 5B is a functional block diagram illustrating an alternative embodiment of a control system in accordance with the invention;

FIG. 6A is a functional block diagram illustrating an operator interface of the device of the invention;

FIG. 6B is a functional block diagram of an alternative embodiment of an operator interface of the device of the invention;

FIG. 7 illustrates one embodiment of a data storage of the device of the invention;

FIG. 8 illustrates a device of the invention communicating with one or more remote devices or systems in accordance with a method of the invention;

FIG. 9A illustrates a device of the invention transmitting data to another electronic device according to one embodiment of the invention; and

FIG. 9B illustrates a device of the invention transmitting a device control program to another electronic device according to one embodiment of the invention.

### DETAILED DESCRIPTION OF THE INVENTION

The invention is a method and apparatus for collecting and sharing information with others. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a device configured to both collect information obtained from others and to share information with others. In a preferred embodiment, the device is configured to: (1) load and store information and then transmit that stored information; and (2) receive information and store that information for later retrieval. The device includes an operator selector for initiating or selecting functions or features, and an operator indicator for indicating the status of the device. Preferably, the device is portable.

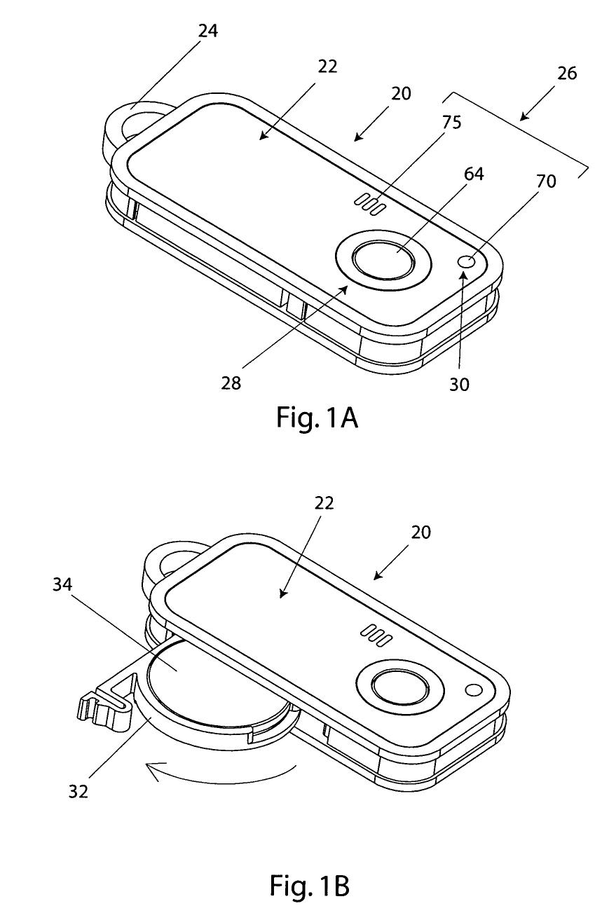

FIG. 1A is a perspective topside view of one embodiment of a device 20 of the invention. As illustrated, the device 20 includes a support structure for the various components of the device. In one embodiment, the support structure comprises a housing or enclosure 22. The enclosure 22 defines, as described in more detail below, an interior space in which various components are located.

Still referring to FIG. 1A, in a preferred embodiment, the device 20 includes an attachment point 24 and an operator interface 26. In the embodiment illustrated, the operator interface 26 comprises at least one selector 28 and at least one indicator 30. As illustrated, the selector 28 comprises a button 64, and the indicator 30 comprises a light 70 and, as described in more detail below, a tone or sound generator (not shown). Though in the preferred embodiment the indicator 30 of the device 20 comprises at least one light and a tone generator, the indicator 30 may be configured in alternate fashions, such as to comprise only one or more lights or only a tone generator.

As described above, the device 20 of the invention is, in its preferred embodiment, portable. In one embodiment, various of the components of the device 20 are thus preferably battery-powered. As illustrated in FIG. 1B, the device 20 includes a battery holder 32 for holding a battery 34. To provide convenient access to the battery 34, the battery holder 32 is preferably movable between a first position and a second position. In the first position, the battery holder 32 is retracted and the battery 34 is located in the enclosure 22 of the device 20. In the second position, as illustrated in FIG. 1B, the battery holder 32 is extended outwardly from the enclosure 22, providing access to the battery 34.

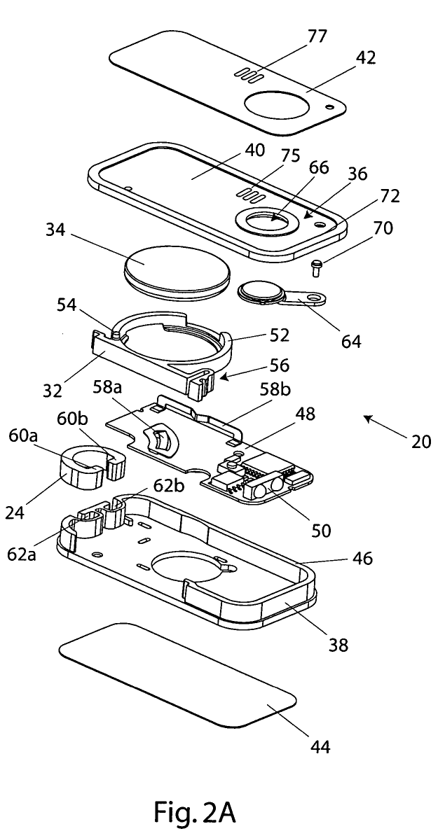

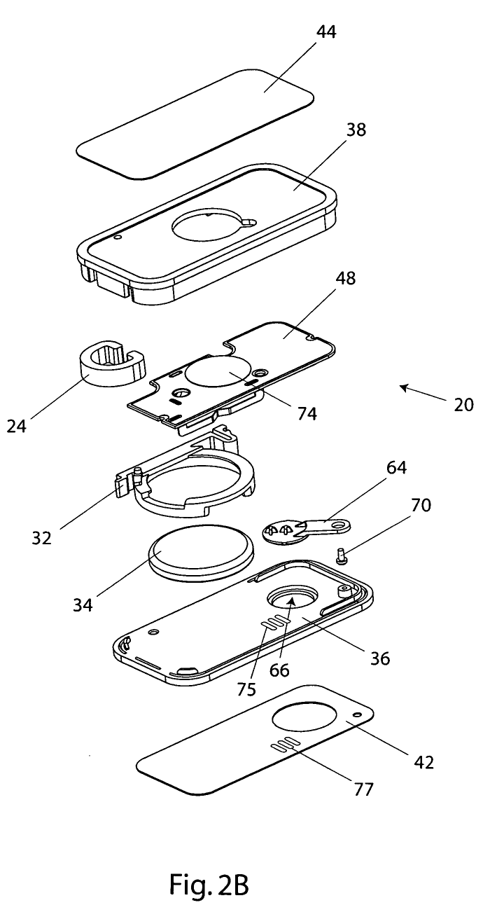

The battery holder 32 may be configured in a variety of fashions to move as described. In a preferred embodiment, as described in greater detail below and illustrated in FIG. 2A, the battery holder 32 is pivotally or hingedly connected to the enclosure 22 for swinging or rotating movement. The battery holder 32 may be mounted for movement in other fashions, including by sliding in and out. The battery holder may be assembled to be integral with the device enclosure or be separable from the device enclosure.

Additional aspects of a configuration of the device 20 in accordance with one embodiment of the invention will be described with reference to FIGS. 2A and 2B. Referring to FIG. 2A, the enclosure 22 of the device 20 is generally defined by a top enclosure case 36 and a bottom enclosure case 38. The top enclosure case 36 and bottom enclosure case 38 are configured to be joined to form the enclosure 22 defining an interior space.

As illustrated, the top enclosure case 36 and bottom enclosure case 38 are generally rectangular in profile shape, being longer than they are wide. As assembled, the enclosure 22 is thus similarly shaped, as illustrated in FIGS. 1A and 1B. It will be appreciated that the shape of the enclosure 22 may vary. For example, the enclosure 22 may be generally circular, oval, square or even irregular in shape. Preferably, the top enclosure case 36 and bottom enclosure case 38 are sized so that the resulting enclosure 22 is small, facilitating portability of the device 20. In one embodiment, the total length of the enclosure 22 (not including the attachment point 24) is about 2 inches, the total width is about 1 inch, and the depth of the enclosure is about 0.25 inches. When the enclosure 22 has a different shape, it is desired that the maximum spanning dimension (whether side-to-side, across a diameter or the like) be no more than about 2 inches and the maximum depth be no more than about 0.25 inches. In general, it is desired that the device 20 have a size similar to a car or house key: sufficiently small to be easily transported, and yet sufficiently large to be manipulated by an operator.

In one embodiment, an outwardly facing surface of the top enclosure case 36 has an inset portion 40 for accepting a label 42. As illustrated, the inset portion 40 is set within an upwardly extending lip which generally extends around the circumference or edge of the top surface of the top enclosure case 36. The label 42 may include graphics to make the enclosure 22 aesthetically pleasing. The label 42 may also include instructions or other useful information. The label 42 may be connected to the top enclosure case 36 with adhesive. Similarly, the bottom enclosure case 38 includes an inset portion for accepting a bottom label 44. In one embodiment, the labels 42,44 are primarily for aesthetic purposes only, and bear graphics. In such an embodiment, the labels 42,44 may be removable or replaceable, permitting the owner to change them to “customize” the appearance of the device 20 to their taste.

As illustrated, the top enclosure case 36 is generally planar. The bottom enclosure case 38 has an upwardly extending wall 46. As illustrated, the wall 46 extends upwardly around at least a portion of a perimeter of the bottom enclosure case 38. This wall 46 substantially defines the depth of the interior space of the enclosure 22.

The enclosure 22 houses or supports various components. In one embodiment, a component board 48 is preferably located in the enclosure 22. The component board 48 supports various components. In one embodiment, these components include control system components such as a processor and at least one data storage device (not shown in detail), as well as a data exchange device which, as illustrated, comprises an infrared wireless transceiver 50.

As illustrated, the battery holder 32 includes a generally circular support 52 for accepting a circular battery 34. The shape of the battery holder 32 may vary depending on the configuration of the battery 34. In the embodiment where the battery holder 32 is pivotally mounted, the battery holder 32 includes a pin 54 configured to engage corresponding apertures in the top enclosure case 36 and bottom enclosure case 38. As illustrated, the battery holder 32 is configured to rotate in and out of the enclosure 22 through an opening in the wall 46 of the bottom enclosure case 38.

In one embodiment, the battery holder 32 includes a latch 56 comprising a compressible “U”-shaped element. The latch 56 is configured to selectively engage a portion of the wall 46 of the bottom enclosure case 38. When the latch 56 engages the wall 46, the battery holder 32 is held in its position illustrated in FIG. 1A within the enclosure 22. When the latch 56 is released, such as by compressing it away from the wall 46, the battery holder 32 may be moved to the position illustrated in FIG. 1B.

Referring again to FIG. 2A, first and second battery contacts 58a,b are preferably mounted to the component board 48. The battery contacts 58a,b contact the appropriate portions of the battery 34 when the battery holder 32 is located in the enclosure 22. As illustrated, one battery contact is mounted to contact a bottom portion of the battery 34 and the other contact is configured to contact an edge portion of the battery. Though not illustrated, the battery contacts 58a,b are connected by wires, leads or other conductive members to various other components of the device 20 to provide power thereto. The battery contacts 58a,b may be arranged in other configurations, including by attachment to the bottom enclosure member 38.

In the embodiment illustrated, the attachment point 24 comprises an attachment ring which is connected to the enclosure 22. In a preferred embodiment, the attachment ring is “C”-shaped, having a pair of legs 60a,b which engage mating recesses 62a,b formed in the wall 46 of the bottom enclosure case 38. As illustrated, the legs 60a,b are configured to engage the recesses 62a,b in a sliding configuration, permitting the attachment ring to be disconnected from the enclosure 22.

The device 20 may include other attachment points. For example, the attachment point may simply comprise an aperture passing through the enclosure 22 for accepting a cord therethrough. The device 20 may also include multiple attachment points.

As illustrated, in a preferred embodiment, the selector 28 comprises a button 64 mounted in the enclosure 22 and accessible through an opening 66 formed in the top enclosure case 36. As illustrated, the button 64 and the corresponding opening 66 are generally circular in shape, though they may have other shapes. The button 64 is arranged as a push-type button moveable between an undepressed and a depressed position. The button 64 is biased to its undepressed position. In one embodiment, this may be accomplished by mounting the button 64 to a biasing arm, as illustrated. Biasing means, such as a spring or the like may also be utilized.

A light emitting diode (LED) 70 comprising the indicator 30 is aligned with an opening 72 in the top enclosure case 36 for viewing by a user. Though not illustrated in detail, the LED 70 mounts to a socket or is otherwise connected to other components of the device 20 for selectively providing power to the LED for illuminating it. Of course, the indicator 30 may comprises other types of light-emitting elements other than an LED.

As illustrated in FIG. 2A, various components of the device 20 are associated with, such as by being connected to, the component board 48. Referring to FIG. 2B, in one embodiment, one or more components are associated with a bottom portion or side of the board 48. In particular, in one embodiment, a sound or tone generating device 74 is located at the bottom of the board 48.

In one embodiment, the sound generating device 74 comprises an element configured to emit at least one audible tone. The sound generating device 74 may be configured to emit tones of a variety of frequencies and in a variety of patterns or sequences.

As illustrated in FIGS. 1A, 2A and 2B, the enclosure 22 may have one or more apertures 75 formed therein for transmitting generated sounds, such as tones, from the sound generating device 74 to the operator. As illustrated, a plurality of apertures 75 are formed in a grill-like formation in the top enclosure case 36 of the enclosure 22. Similar apertures 77 are preferably formed in the top label 42 for alignment with the apertures 75 in the top enclosure case 36.

As just described, in this embodiment, the selector 28 comprises a single push-type button 64. The operation of such a button 64 is described in more detail below.

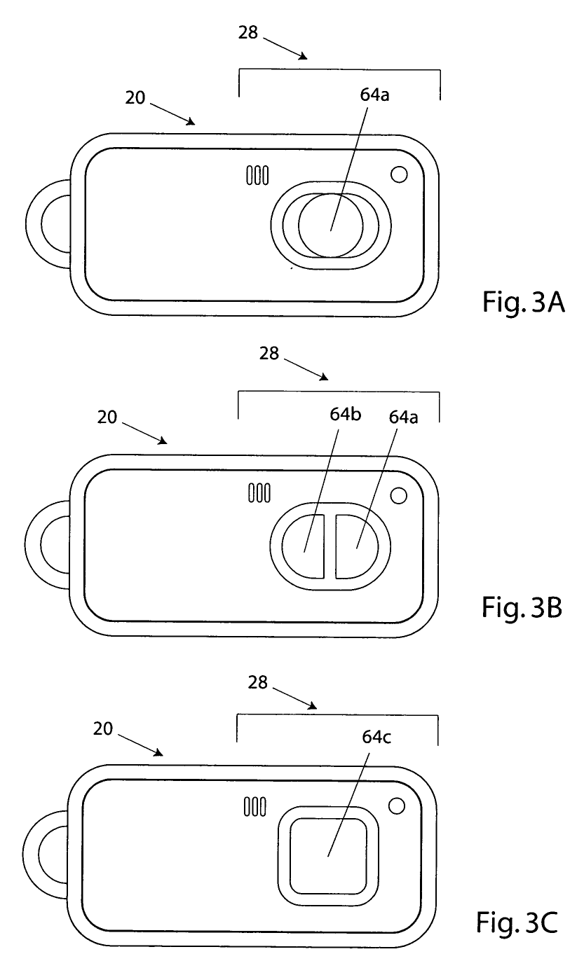

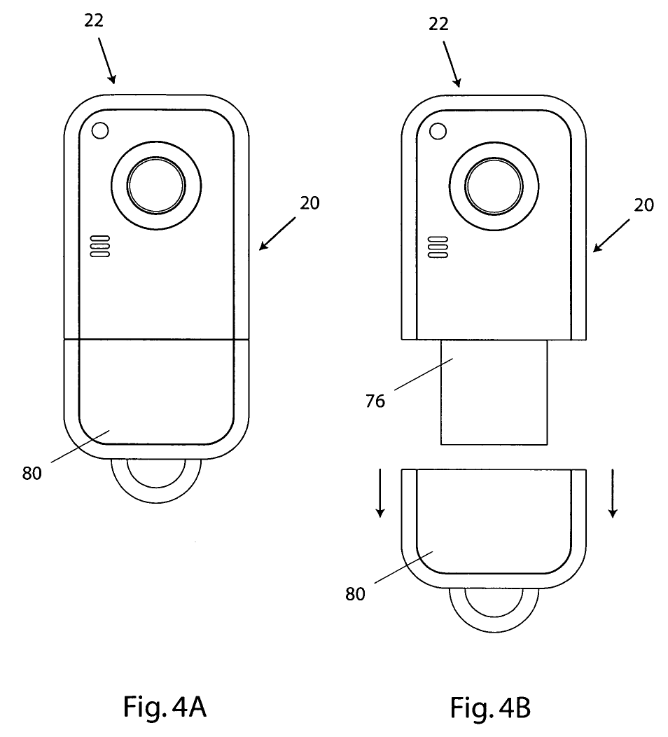

FIG. 3A illustrates another embodiment of a selector 28 of the device 20 of the invention. As shown, the selector 28 also comprises a multi-position button 64a. The button 64a extends through an enlarged opening 66a which permits the button 64a to move laterally between one or more positions. As illustrated, the button 64a is configured to move between a central position, a forward position and a rearward position. The button 64a is preferably biased to its central position. The operation of such a button 64a is described in more detail below.

FIG. 3B illustrates another embodiment of a selector 28 of the device 20 of the invention. In this embodiment, the selector 28 comprises a first button 64b and a second button 65b. The buttons 64b,65b are push type buttons. Various features may be effected by depressing either or both buttons 64b,65b, as described in more detail below.

FIG. 3C illustrates yet another embodiment of a selector 28 of the device 20 of the invention. In this embodiment, the selector 28 comprises a sensor 65c, such as a capacitive switch, a biometric sensor, such as a fingerprint sensor, or other device which may be activated by the operator, either directly or remotely.

It is noted that the location of the selector 28 with respect to the enclosure 22 may vary. Preferably, the selector 28 is positioned ergonomically.

The device 20 is configured to transmit and receive data. In a preferred embodiment, the device 20 includes a data exchange interface or device. In one embodiment, this device comprises the wireless infrared transceiver 50, as best illustrated in FIG. 2A. In such a configuration, the bottom enclosure casing 38 may either be constructed of a material which transmits an optical signal, or may include an opening or a window of such material which permits such.

The data exchange interface may comprise other elements. For example, the interface may comprise other wireless transceivers, such as those operating on other principles and frequencies, including the IEEE 802.11(xx) standards, and Bluetooth. As described below, it is preferred that the device 20 utilize an infrared transceiver, as such has particular advantages as to the device of the invention. Among other things, whereas RF transceivers are omnidirectional in their functionality, infrared transceivers are directional constrained in their functionality, providing the operator the ability to control the interaction of the device based on the direction in which the device is pointed. Additionally, radio frequency or RF transceivers, such as those which implement the 802.11(xx) standards, currently have high power consumption rates which are inconsistent with the goals for the device of the invention.

The device 20 may also include other forms of data exchange interfaces, including such an interface configured to transmit and/or receive data via a direct connection. FIG. 4A illustrates an embodiment of the device 20 including a physical interface 76. As illustrated, the physical interface 76 is a universal serial bus connector. The physical interface 76 may have a variety of other configurations, such as a serial 9-pin or parallel multi-pin connector, or a connector or plug meeting the Firewire® (IEEE-1394) or serial ATA standards.

In one embodiment, though not illustrated, the physical interface 76 may be accessible through an opening in the enclosure 22. In another embodiment, as illustrated in FIG. 4A, the physical interface 76 may be accessible by opening or removing a section of the enclosure 22. In particular, as illustrated in FIGS. 4A and 4A, the enclosure 22 may include a removable cover 80. As illustrated, the cover 80 maybe moved from one position (FIG. 4A) in which it engages the remaining portion of the enclosure 22 and covers the physical interface 76, to a second position (FIG. 4B) in which it is removed and the physical interface 76 is exposed. In this second position, the physical interface 76 may be connected to a mating member, such as a mating USB port, connecting wire or the like.

In the embodiment illustrated, the cover 80 slides into and out of connection with the remainder of the enclosure 22. The cover 80 may be configured in other fashions. For example, the cover 80 may be hingedly connected.

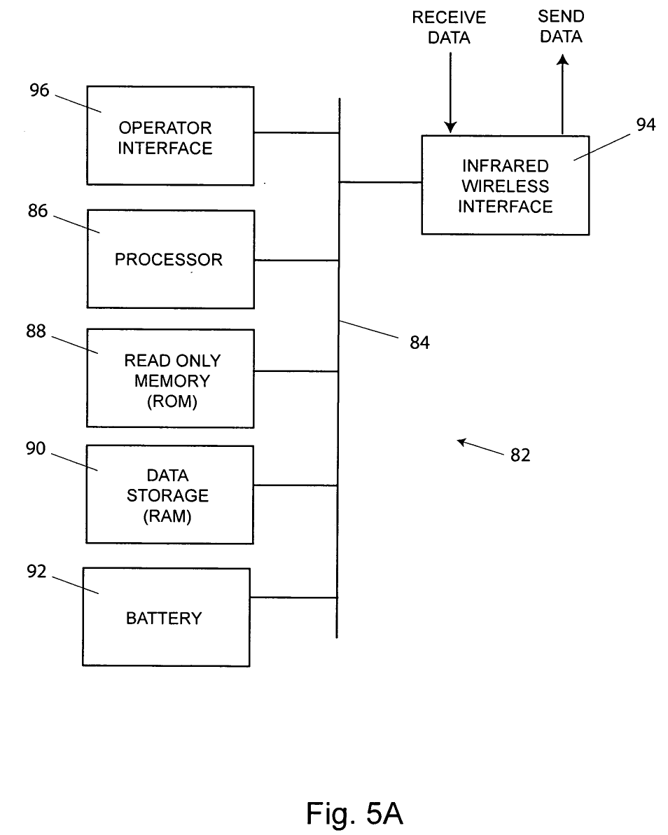

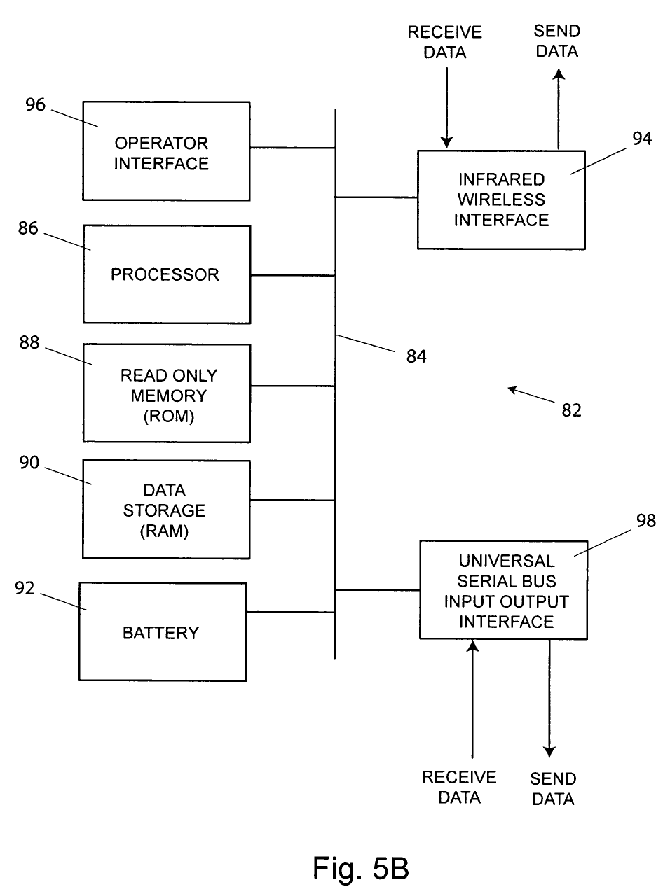

The device 20 preferably includes elements for storing data and for effecting the receipt and storage of data. FIG. 5A illustrates one embodiment of a functional block diagram of a control system 82 of a device of the invention. In a preferred embodiment, the control system 82 corresponds to the device 20 illustrated in FIG. 1A and B. It will be appreciated, however, that the system 82 may be utilized in other devices. The system 82 may comprise a number of components which are either separate or integrated, and which may be configured or represented as hardware and/or software.

As illustrated, the system 82 includes a system bus 84. The bus 84 is configured to route data between various other components. In the configuration illustrated, these components include a processor 86, a first data storage 88, a second data storage 90, a power source 92, a data exchange interface or device 94, and an operator interface 96. The components may be connected through a single bus or more than one bus. For example, a memory component may be integrated with a processor and those components may communicate by an internal bus, that bus independent of the system bus 84.

The processor 86 is preferably configured to perform or initiate functions or operations, preferably by execution of instructions provided in the form of machine readable code. The processor 86 may have a variety of configurations and may comprise hardware and/or software (i.e. machine readable or executable code). The processor 86 may be one commercially available, such as those manufactured by Intel, AMD, Atmel, Microchip or Sun, among others.

The first data storage 88 preferably comprises a non-volatile memory device, such as a read-only memory or data storage device (ROM). In this configuration, the first data storage 88 serves as a “permanent” memory, in the sense that it is configured so that it is not readily re-written. This memory may, along with the processor, comprise a microcontroller of the device 20.

The second data storage 90 preferably comprises a re-writeable memory. The second data storage 90 may be of a variety of types, such as EEPROM, RAM or Flash memory, all of which permit data to be stored and new data to be overwritten over old data. In one embodiment, the second data storage 90 may be used to store primary and secondary data, as described in more detail below. This type of memory might also be used to temporarily store program data for execution by the processor.

In one or more embodiments, the device 20 may include additional data storage or memory elements. These elements may be separate from those detailed above, or could comprise a portion of one or both of those memories. For example, in one embodiment, the second data storage 90 comprises one physical memory storage device, and that device is external to the microcontroller/processor. A third data storage may comprise re-writeable memory such as RAM. The third data storage maybe associated with the microcontroller/processor and, as described above, temporarily store data for execution by the processor. Also, a fourth data storage may be configured to store device setting data. In one embodiment, this fourth data storage may comprise re-writeable memory such as RAM, and thus may be referred to as “parameter RAM.” This memory may be configured to store information between power-ups of the device 20 such as security settings and the like.

Regardless of the form the first and second data storage 88,90 takes, it is preferred that the memory device or devices be small in size to keep the device 20 compact. For example, it is preferred that the memory not be a hard drive, CD-RW or similar devices which in their current configurations are large in dimension.

In one embodiment, the first and second data storage 88,90 may actually comprise the same physical device. For example, the memory may be partitioned so that a portion of the memory serves the purpose of the first memory and another portion serves the purpose of the second memory.

As described, in a preferred embodiment, the power supply 92 for the control system 82 comprises a battery, such as the battery 34 illustrated in FIGS. 1B and 2A and B.

As also described above, the operator interface 96 may comprise one or more elements, including one or more selectors and/or indicators such as buttons, lights and the like. The data exchange device 94 preferably comprises the infrared wireless transceiver 50 as illustrated in FIG. 2A and described above, but may have other forms.

In the configuration illustrated in FIG. 5A, data is preferably temporarily stored in the second data storage 90. New data may be received by the data exchange device 94 and routed via the bus 84 to the second data storage 90. Stored data may be likewise routed from the second data storage 90 to the data exchange device 94 for transmission. Instructions to send and receive are preferably received from the operator interface 96. The processor 86 may execute instructions received by the data exchange device 94 or resident at the first data storage 88. Particular aspects of the operation of the device 20 are described in more detail below. It will be appreciated that the data may be processed by the processor, such as to prepare the data for transmission by the data exchange device 94.

FIG. 5B illustrates another embodiment of a system 82 of the invention. As illustrated, the device again includes a bus 84, processor 86, first data storage 88, second data storage 90, power source 92, data exchange device 94 and user interface 96. In addition, the device includes a second data exchange interface or device 98. In the preferred embodiment, this device comprises a wired or direct connection type device, such as the USB port/plug of the device as illustrated and described in FIGS. 4A and B. As illustrated, the second data exchange device 98 is preferably also associated with the bus 84, permitting data to be provided to and from the bus 84, and thus other components of the device.

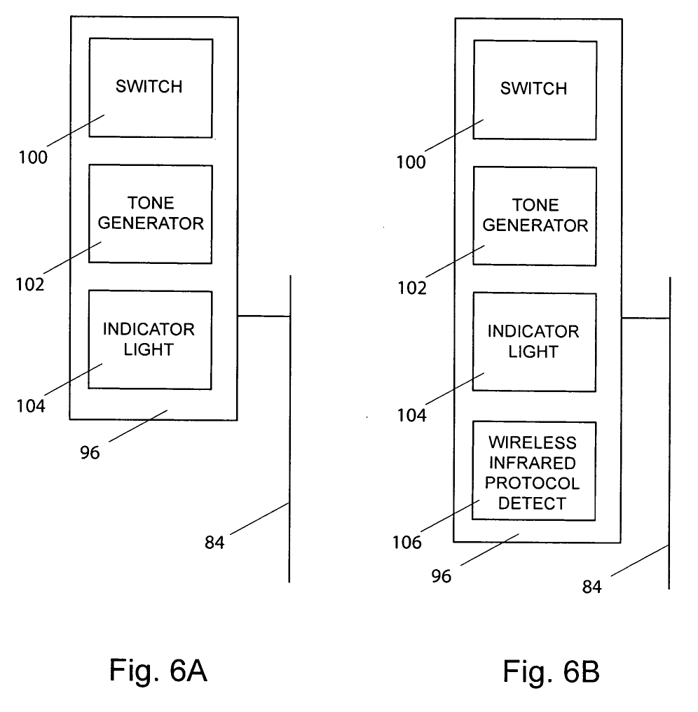

FIG. 6A is a functional block diagram of one embodiment of an operator interface 96 of a device of the invention. As illustrated, the operator interface 96 comprises one or more selectors 100, one or more tone generators 102 and one or more lights 104. A specific configuration of such an embodiment of an interface 96 is the operator interface 28 illustrated in FIG. 1A, details of which are described above. As illustrated, the components are preferably associated with the bus 84 of an operational system, such as that illustrated in FIGS. 5A or B. Additionally, the interface may augment the switch with more complex devices such as the fingerprint reader or other devices described above.

FIG. 6B is a functional block diagram of an alternative embodiment an operator interface 96 of a device of the invention. As shown, the operator interface 96 includes one or more selectors 100, one or more tone generators 102, one or more lights 104 and at least one detector 106. Preferably, the detector comprises a wireless data transmission detector, such as a wireless infrared protocol detector. This detector is preferably configured to detect the existence of transmitted signals and then place the data exchange device 94 into a condition to receive such signals. In a preferred embodiment, the function of the detector 106 is to enable the device 20 to function in a low power “sleep” state. In that state, the detector 106 may remain awake to detect other devices/signals, while other of the components are placed in sleep mode.

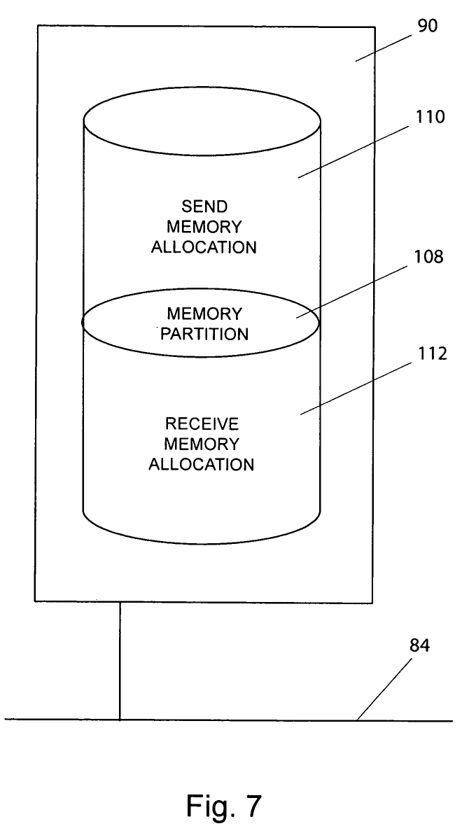

FIG. 7 illustrates one configuration of a memory of the device of the invention. Preferably, FIG. 7 illustrates a configuration of the second data storage 90 of the operational system of the device, as illustrated in FIGS. 5A and B.

As illustrated therein, the second data storage 90 includes a memory partition 108. The memory partition 108 is a could be a physical partition, but is preferably a dynamic electronic partition which divides the data storage 90 into at least a first portion or first memory allocation 110 and a second portion or second memory allocation 112. The “location” of the partition is preferably adjustable, thereby varying the relative size of the first and second portions of the data storage 90. In one embodiment, as illustrated, the first memory portion 110 comprises a “primary data” memory portion or allocation and the second memory portion 112 comprises a “secondary data” memory portion or allocation.

In one embodiment, the location of memory partition 108 may be statically set by the device 20 based on the system program instructions, such as those stored in the first data storage 88. Alternatively, the location of memory partition 108 may be dynamically set using settings chosen by the operator using a host program (described in more detail below), such as by selection of device settings. In one embodiment, the second data storage 90 may be non-volatile to reduce or minimize the loss of any data due to a loss of power, such as if the battery 34 dies or is replaced.

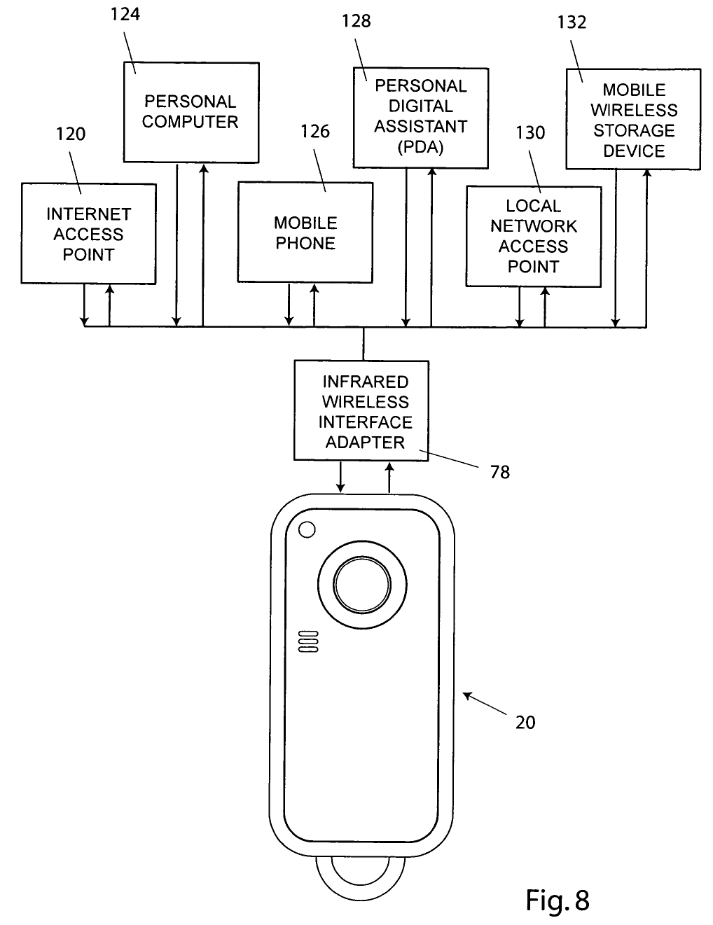

Various methods of the invention, including aspects of the operation and use of the device of the invention will now be described. Referring first to FIG. 8, the device 20 of the invention is illustrated communicating with one or more other devices or systems. These devices or systems may include, but are not limited to, an Internet access point 120, a personal computer 124, a mobile phone 126 a personal data assistant (PDA) 128, a local network access point 130, and a mobile wireless storage device 132. Most preferably, a device 20 of the invention is also configured to communicate with another device (not shown) of the invention. In one embodiment, communications may be facilitated with the aid of a communication protocol adapter 78. When the device 20 is to communicate using its infrared wireless transceiver, the adapter 78 maybe an infrared interface protocol adapter. When the device 20 communicates using a different communication medium (such as an RF device), the appropriate communication adapter must be utilized.

The device 20 of the invention may communicate with another device or devices in many ways. In one embodiment, as described above, the device 20 may include a physical data exchange interface such as a USB port or similar wired or hard-connect data exchange interface. Thus, the device 20 may be directly connected to another device. For example, the USB plug of the device 20 illustrated in FIG. 4A may be inserted into a mating port of a personal computer or PDA.

Most preferably, however, the device 20 is configured to communicate with other devices via a wireless communication link. As described above, such a link may be established between the wireless data exchange interface 94 of the device 20, and a corresponding interface of another device. In one embodiment, such a link is established between the infrared transceiver of the device 20 and a corresponding receiver, transmitter and/or transceiver of the other device. In this configuration, data maybe exchanged between the device 20 and another device 20 of the invention, or any of a variety of other devices or systems, such as those illustrated in FIG. 8.

In one embodiment, device 20 is configured to implement three primary operations: (1) Load and Store; (2) Read and Send; and (3) Receive and Store. These operations are preferably initiated or selected by the operator through the use of the operator interface, such as the interface 96 illustrated in FIGS. 6A and B. In general, the first two operations enable the user to operate with a “primary” set of data that the user is able to load into the device 20 and share with other devices. The third operation enables the user to collect “secondary” data sets that are provided from other devices. These “secondary” data sets may then be retrieved by the user from the device 20 at some later point (as described below).

In one embodiment, the device stores only a single primary data set. This enables the device to store a single set of data and be able to share that data with other devices it can communicate with. In this specific design, the device does not enable the storage of any secondary data and it cannot store data sets it receives for later retrieval by a host interface program (also described below).

The existence of secondary memory in the device can change the methods in which the user interacts with the device. In some case, the program memory will contain memory to handle or control both (including and excluding secondary memory). In another embodiment, the device may contain secondary memory but the use of this memory can be activated or deactivated through a setting in the device 20 that can be controlled through host interface software (described below).

In one preferred embodiment, the device 20 of the invention is particularly useful in exchanging data formatted according to the personal data interchange (PDI) specification maintained by the internet mail consortium such as vCard and vCalendar. This format specifies the electronic storage of business cards and calendar data in a generalized format that can be freely interchanged between different devices. Additional details of this function are described below. In general, however, the “Load and Store” and “Read and Send” data functions permit an operator to load their electronic business card information to the device 20, store that information, and then later transmit the information to other parties, such as a third party's device or computer. In addition, the “Receive and Store” function allows the operator to receive electronic business card information from one or more third parties, store that information at the device 20, and then retrieve the information for later use.

In one embodiment, the processor 86 processes inputs from the operator interface 96 and initiates the selected function according to instructions stored in memory, such as the first data storage device 88. In one embodiment, whenever the device 20 has been inactive for a period of time, the processor 86 suspends system operation pending input from operator interface 96 to save power, such as provided by the battery 34. If the device 20 is in a suspended state when the operator engages the operator interface 96, the processor 86 places the device 20 back into mode of full operation.

Data, such as a file, may be transmitted or sent. In a preferred embodiment, the data to be sent is stored in the primary data memory storage 110. As such, one embodiment of the invention is a method of loading data to the primary data memory storage 110 so that it may thereafter be transmitted or sent. In a preferred embodiment, the operator differentiates between these two functions through use of the operator interface 96. In the embodiment illustrated in FIG. 1A, the operator preferably actuates or presses the button 64 for a period of time to distinguish between the two device operations. In one embodiment, the duration the selector is activated is used to distinguish between the two device modes. If the duration is less than 15 seconds, for instance, the device 20 could execute one operation. If the duration is longer, then the other operation would be executed.

During both of these operations, the device 20 is in a state where it is capable of receiving a data set. Once the data set has been received into memory, the current operation that the device is executing determines where the data set will be stored in memory. If the device is currently executing a “Load and Store” operation, the data set is stored as the primary data set in the primary data memory allocation 110. However, if the device 20 is currently executing a “Receive and Store” operation, then the data set that is received is stored in the secondary data memory allocation 112.

When the operator interface 96 has been so activated in such a manner so that it executes the “Load and Store” operation, the processor 86 causes the device 20 to be placed into a state where it is ready to receive the data, such as the single electronic file, and store it in the primary data memory allocation 110.

In this state the data, such as the single electronic file, may be received from another device, such as one of the devices illustrated in FIG. 8. In that embodiment, the data is received via the data exchange device 94 and is loaded into the send memory allocation 110, automatically erasing and overwriting any previous data in that memory allocation.

When the operator is successful in executing an operation, the device 20 may provide an indication of which operation has be executed and the outcome or success of the operation. This may be provided by the indicator light 70 and/or tone generator 74 or other indicator of the device.

When data, such as a single electronic data file, is stored in the primary data memory allocation 110, that data may be transmitted from the device 20 to another device, such as one of the devices illustrated in FIG. 8 or another device 20 of the invention. In accordance one method, the operator initiates the send or transmit from primary data memory allocation 110 function with the operator interface 96. In a preferred embodiment where the operator interface 96 includes the button 64 illustrated in FIG. 1A, this comprises the operator depressing the button 64 for a period of time. In one embodiment, this period of time is less than that necessary to initiate the “load” function as described above. In one embodiment, the time is between about 3 and 15 seconds. In one embodiment, these time values can be variable and set through the use of the host interface program. At that time, the data in the primary data memory allocation 110 is transmitted through the bus 84 to the data exchange interface, such as the data exchange device 94, where it is transmitted from the device 20 as a signal. This signal may be received by various devices, including another device 20 of the invention or one of the devices illustrated in FIG. 8.

Once again, when the operator is successful in initiating the “send” function, an indication of such may be provided to the operator. For example, the indicator light 70 and/or tone generator 74 may be activated to provide information regarding failure or success of the operation.

In another operation or method, the device 20 may receive a file for storage (rather than for sending). In one embodiment, this comprises preparing the device 20 to receive data and storing that data in the secondary data memory allocation 112.

Once again, the “receive” function is preferably initiated with the user interface 96. In the case of the interface 28 illustrated in FIG. 1, the operator preferably depresses the button 64. In a preferred embodiment, the operator initiates the “receive” function by depressing the button 64 a length of time less than that necessary to initiate the “send” function. In one embodiment, this time is less than 3 seconds. In another embodiment, the time duration can be set through the use of a host interface program.

When this input is provided, the processor 86 preferably places the system into a state where it is ready to receive incoming data, such as an incoming electronic data file in infrared signal format transmitted from another device. The signal is received by the data exchange device 94, such as the infrared wireless transceiver 50 of the device illustrated in FIG. 2A.

The data which is received is transmitted to the secondary data memory allocation 112. In a preferred embodiment, more than one set of data, such as a plurality of files, may be stored in the secondary data memory allocation 112. Of course, the amount of data which may be stored depends upon the size of the memory. In this manner, data may be received at different times and stored in the memory at the same time.

Once again, the operator may be provided an indication of the success or failure of the “receive” function via the indicator light 70 and/or tone generator 74. If during the receive operation the available secondary data memory allocation 112 is exceeded, an error tone can be played by the tone generator 74 and the indicator light 70 can flash an error code and error color to alert the operator.

Most importantly, data which is stored in the secondary data memory allocation 112 can be retrieved. For example, after a group of electronic data files have been collected by the operator, the operator may desire to transfer the electronic data files to some other device, such as one of the device illustrated in FIG. 8.

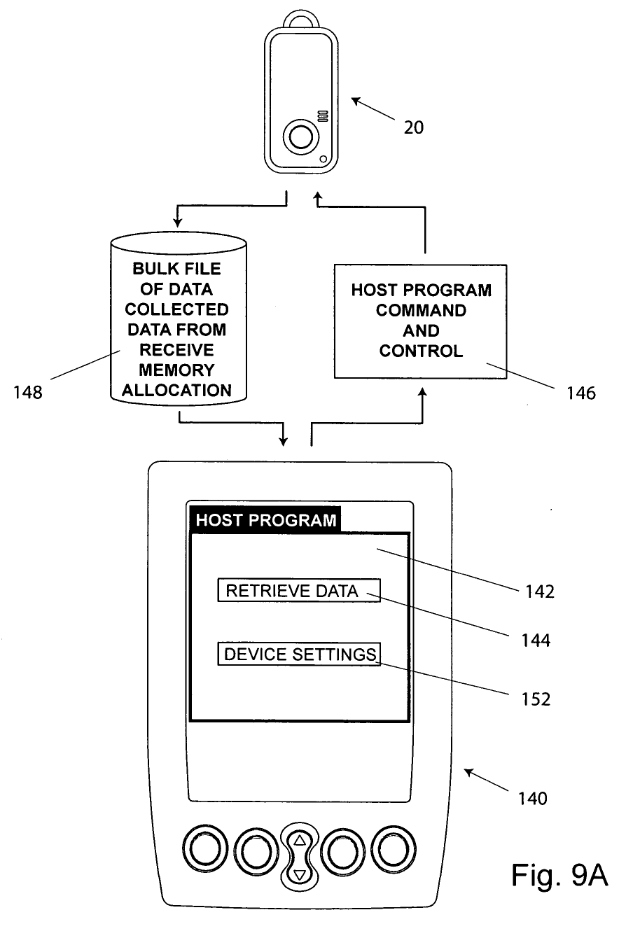

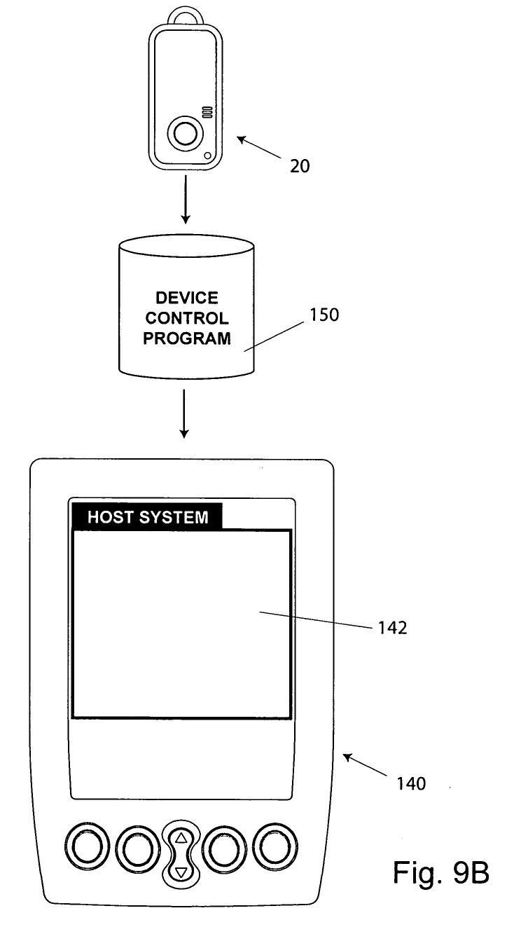

In one embodiment, the retrieve function may be initiated using the operator interface 96. For example, the user might depress the button 64 for a period of time which exceeds that necessary to invoke the “load” function, depress the button twice in a certain period of time, or the like. In a preferred embodiment, however, the retrieve function is initiated from another device. FIGS. 9A and B illustrate embodiments of this aspect of the invention.

As illustrated in FIG. 9A, a remote device 140 is in communication with the device 20 of the invention. As illustrated, the remote device 140 is a PDA. The remote device 140 could be any of a variety of devices, such as one of the other devices illustrated in FIG. 8.

As illustrated, the remote device 140 is in communication with the device 20 via a wireless communication link with the data exchange device 94 of the device 20. As illustrated, the remote device 140 is configured to execute a host program or function may preferably includes a graphical user interface (GUI) 142 displayed on a display of the remote device or a display associated therewith. The GUI 142 includes user-selectable elements for initiating actions or functions. In one embodiment, a user-selectable element is provided corresponding to a retrieve data 144 function.

In accordance with one embodiment of the invention, when the operator initiates the retrieve data function 144, the remote device 140 transmits a host command and control program 146 to a device 20 of the invention. The program 146 is preferably transmitted as data in signal format, such as via an infrared wireless communication signal to the data exchange interface of the device 20.

In a preferred embodiment, the host command and control program 146 is accepted at the device 20 and processed by the processor of the device 20. The program 146 preferably causes the device 20 to transmit the data stored in the retrieve memory allocation 122. This data may be transmitted as a bulk file 148 from the device 20 back to the remote device 140. Other embodiments of the invention support multiple different commands from the remote device 140 to the device 20 in order to execute different functions on the device 20. The processing for some commands trigger the device 20 to transmit the retrieve memory allocation 122 to the remote device 140. Other commands execute other functions such as querying the device status, adjusting the device operational settings, and authorizing a security value for the device.

In one embodiment, the device 20 maybe configured to store and transmit data to a remote device 140 for use by the remote device in implementing the retrieve function. Referring to FIG. 9B, a device control program 150 may be stored by the device 20. This program 150 may be transmitted from the device 20 to a remote device 140. The remote device 140 may then install and/or execute the control program 150, causing it to set up or run the host program described above. The operator of the remote device 140 can then use that device to initiate the retrieve function as just described.

Referring again to FIG. 9A, once the data is retrieved from the device 20 by the remote device 140, whether as a bulk file 148 or otherwise, that data may be stored or used at the remote device 140. For example, the data could be displayed on the display of the remote device 140, transferred to other devices, or stored for later use.

Following retrieval of electronic data files from the secondary data memory allocation 112 of the device 20, the operator may choose to erase or retain the data in the secondary data memory allocation 112. In one embodiment, the operator may use the operator interface 28 of the device 20 to clear the secondary data memory allocation 112. In another embodiment, such may be accomplished from a remote device 140 through a command executed through the host program control link 146.

Referring still to FIG. 9A, as illustrated, the host program on the remote device 140 may include a device settings function 152. This function may allow the operator to communicate configuration instructions to the device 20. For example, as described above, the operator may utilize the device settings function 152 to change the memory partition 108 so that more or less memory is dedicated to the secondary data memory allocation 112. The device settings function 152 may also be utilized to clear the primary data memory allocation 112, secondary data memory allocation 110 or change other parameters or take other actions.

Selections of these various device setting functions may be by any of several different graphical interfaces menu which is displayed on the display of the remote device 140 when the function 152 is selected by the operator. When a function is selected by the user, appropriate data is preferably transmitted to the device 20, which data is used by the processor 86 of the device 20 to affect the device setting selection.

The arrangement of components of the device of the invention, including their configuration and assembly, including the associated enclosure, may vary. For example, in one embodiment, processor and first data storage of the device 20 illustrated in FIGS. 5A and B may be combined in a standardized microcontroller having an internal ROM or FLASH memory with a suitable embedded program arranged to cause the operational system to perform the functions indicated. Of course, the methods of the invention may be applicable to a variety of devices, including various forms of the device of the invention.

As described above, the device of the invention may be implemented in various configurations and the method of the invention may vary, including as dependent upon the configuration of the device.

As one example, in one embodiment as illustrated in FIG. 3A, the operator interface comprises a sliding button 64a. In one embodiment, movement of the button 64a to one position, such as a forward position effects one function (such as a send operation), and movement to the rearward position initiates another function (such as the receive operation). Additional functions may be assigned to the button 64a based on the length of time button 64a is held by the operator in the forward position or the rearward position.

In the embodiment illustrated in FIG. 3B, one function (such as the send operation) may be initiated by activating one button 64a and another function (such as the receive operation) may be initiated by activating another button 64b. Additional functions may be initiated based on the length of time either or both buttons 64a, 64b are engaged by the operator.

In another embodiment, instead of utilizing button positions and/or assigning functions to periods of time a button is activated, the device could include buttons or other function initiating elements which are assigned or correspond to a single function. For example, the device could include individual buttons assigned to the load/store, send, receive and transfer functions.

The device 20 may include a variety of indicators other than the light and sound generating device described above. For example, the indicator could comprise or include a vibrating motor to provide tactile operator feedback as to the status of the device 20.

In other embodiments, indicator light 70 may illuminate white or colored light (whether directly or through a lens). There may also be two or more indicators lights. Such lights may be configured to provide a variety of information to the operator. For example, the lights may be arranged in a line, with the number of lights illuminated or their sequence providing information such as the status of a function, relative data exchange rate or the like.

For greater economy, in one embodiment, the enclosure 22 of the device 20 could be fabricated entirely of a plastic material optimized for the transmission of infrared light transmission and ultrasonically welded together for increased durability.

In one embodiment, the host program associated with a remote device could be configured to automatically identify a device 20 of the invention, or vise versa. In this manner, the device 20 of the invention and remote devices may identify one another and then facilitate automatic retrieval of data. The identity of the device 20 or remote device 140 may be accomplished using a serial or identification number which is transmitted from the devices to the other.

In a preferred embodiment of the invention, information is loaded to or received by the device 20 and transferred from the device 20 using a wireless communication device implementing a wireless communication protocol. In a most preferred embodiment, the wireless communication device is an infrared wireless communication transceiver. As described, however, the communication device may implement other protocols.

As described above, the infrared transceiver has particular advantages over RF and other wireless devices. First, the infrared transceiver uses much less power, a key attribute to the portability of the device. In addition, infrared transmission is directional. In the case of business card transmission, this increases the security that information exchanged between two parties is not distributed to unwanted third parties. For example, at a business negotiation between adversarial parties, this reduces the probability that information being transmitted between two parties with common interests is not “picked up” by an adversary simply because the adversary has a device located in the room (as may easily occur with devices using RF transceivers).

As indicated, however, the device 20 may also or alternatively employ a direct communication link. In one embodiment, this direct link may be via a physical connection of the device 20 to another device. For example, as illustrated in FIG. 4A, the device 20 may include a USB plug for direct connection to a USB port of another device. In another embodiment, the connection may be by a third element, such as a cable. For example, the device 20 might include a USB port to which the first end of a cable may be connected, with the second end of the cable then connected to a port of the remote device. The device 20 could include implement various other forms of connection, such as a FireWire® (IEEE-1394) wired connection or the like.

In such a configuration, an operator may select the particular means by which data is provided to or transferred from the device 20. For example, the operator might directly connect the device 20 to their home computer, such as via the USB port illustrated in FIG. 4A. The operator might then transfer data to the device 20 for storage in the primary data memory. The operator might then later collect data from a third party via the wireless communication transceiver, and store that data in the secondary data memory.

Of course, though not as desired, the wired and/or wireless communication interfaces of the device 20 could be configured for a specific purpose. For example, either interface could permit data transfer in only one direction (i.e. receive or transmit but not both) and/or either interface could be associated with only one memory allocation (i.e. the wired connection for moving data to and from the primary data memory allocation 110 and the wireless connection for moving data to and from the secondary data memory allocation 112).

The device 20 may be configured to alter the data for storage and/or transmission. For example, the processor of the device 20 may be configured to compress received data using a data compression algorithm. In this manner, the device 20 may store more received data. That data may then be decompressed before being transmitted or transferred in compressed form.

In one embodiment of the invention, the host program and the device 20 may implement a challenge and response-based security feature to increase the security of data stored and collected by the device 20 and to prevent unauthorized retrieval of data from the device 20.

In one embodiment, a biometric reader or similar device may be used to receive an input. This input may be used as a “password” for security access to the device 20.

Most importantly, the device is preferably uniquely configured to accomplish its specific functions, eliminating problems associated with known devices and providing decided advantages. The device is specifically configured to include a minimal number of components specifically configured to accomplish the above-described functions. As indicated, the device is very small and is configured to transmit and send data over a wireless communication link, permitting it to be very portable. In fact, due to its size, the device can be connected to a key chain or placed in a pocket, allowing it to be transported anywhere.

In one embodiment, portability is enhanced by use of battery power and selection of component combinations to enhance battery life. For example, in a preferred embodiment, the device includes minimal processor circuitry, only a single button and may include a low power LED. The device may also include a simple, low power tone generating device.

The operator interface includes minimal componentry, simplifying the device and permitting the device to be small. As indicated, the interface may include a single selector, such as a single button, and a single indicator, such as an LED light.

Preferably, the device includes no display cable of displaying data such as alpha-numeric text or the like (e.g. no “graphical” or “alpha-numeric” display). This keeps the device simple to use, keeps power consumption low and allows the device to be smaller than other devices capable of exchanging data.

In a preferred embodiment, the functionality of the device is specifically configured. As indicated, the device may be configured to transmit a loaded data, such as a single file, and receive and store for later retrieval other data, such as files. In this manner, use of the device is not complex or difficult to understand. For this reason, the simplified selector of the invention can be utilized to implement all of the functions. This is a tremendous advantage over other devices which may implement numerous function and utilize a great number of operator interfaces such as graphical displays with complex menus, keyboards, an array of other inputs such as volume controls, on/off buttons and the like, all of which greatly increase the difficulty for the operator in accomplishing the desired task with certainty.

The device and method of the invention are particularly suited to exchanging electronic business cards and similar data. In particular, the device is simply configured to load and store an operator's business card or other information (e.g. advertising data, personal contact information or the like), and then to transfer that data to any other person, at any time, anywhere. Further, the device is simply configured to receive similar data from a number of other parties and then store that data for later retrieval and use.

For example, the operator may load their business card information onto the device at their office and then travel to a remote meeting. The data may be loaded from the operator's computer to the device by either the wireless communication interface or the physical port. At a meeting, the operator may transfer their information to a number of parties and at the same time capture like information from those parties. The data transfer and capture at the meeting is permitted without the need for a direct connection to the other devices and without regarding to the specific configuration (i.e. whether the other device is a laptop computer, PDA, phone or another device of the invention) of the other devices. Upon returning to the office, or via a PDA while traveling or via a plurality of other devices, the operator may download the received information for use. For example, the received information may be retrieved from the device of the invention and then placed in the “contacts” data of the PDA, such as in the program Outlook by Microsoft.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A portable device configured to send, receive and store data comprising:
an enclosure supporting at least one selector, at least one indicator, a first data storage location, a second data storage location and at least one data communication interface, said device configured to implement a first operation comprising the receiving of a first data set via said at least one data communication interface and storing of said first data set in said first data storage location, a second operation comprising sending said first data set to a remote device with via said at least one data communication interface, and a third operation comprising receiving at least one second data set via said at least one data communication interface and storing said second data set in said second data storage location, said at least one selector permitting an operator to initiate at least one of said operators and said at least one indicator providing information regarding the outcome of the operation.

2. The device in accordance with claim 1 wherein at least one data communication interface comprises an infrared wireless transceiver.

3. The device in accordance with claim 1 wherein said enclosure supports at least one battery powering said device.

4. The device in accordance with claim 1 wherein said at least one selector comprises a single button having a first position and a second position.

5. The device in accordance with claim 4 wherein said button has a depressed and undepressed position and wherein a length of time said button is depressed determines the operation which is initiated.

6. The device in accordance with claim 1 wherein said device includes a memory and said first and second data storage locations comprise portions of said memory divided by a partition.

7. The device in accordance with claim 1 wherein said indicator comprises at least one light and a tone generator.

8. The device in accordance with claim 1 wherein the sole operator interface of said device comprises devices not comprising a graphical display.

9. A portable device particularly configured to exchange a primary data set with third parties and receive one or more secondary data sets from one or more third parties, comprising:
an enclosure, said enclosure defining an interior space in which a control system of said portable device is located, said control system including at least one processor, at least a first memory and at least a second memory, a wireless communication interface, at least one communication interface permitting data to be exchanged from and between said wireless communication interface, said at least one processor and said at least one first and second memory device;
at least one selector permitting a user to initiate an operation;
at least one indicator comprising at least one light;
said processor configured to cause said device to receive said primary data set via said wireless communication interface and store said primary data set in said first memory as a result of a first input to said selector;
said processor configured to cause said device to send said primary data set via said wireless communication interface as a result of a second input to said selector;
said processor configured to cause said device to receive a secondary data set via said wireless communication interface as a result of a third input to said selector and store said secondary data set in said second memory;
said device powered by at least one battery; and
said at least one indicator configured to provide information regarding the outcome of an operation.

10. The device in accordance with claim 9 wherein said at least one selector comprise a single button, said first input comprising the depression of said button for a first interval of time, said second input comprising the depression of said button for a second interval of time, and said third input comprising the depression of said button for a third interval of time.

11. The device in accordance with claim 9 wherein said indicator solely comprises at least one light and a tone generator.

12. The device in accordance with claim 9 wherein said wireless communication interface comprises an infrared transceiver.

13. The device in accordance with claim 9 including at least one attachment point permitting said enclosure to be attached to another device.

14. The device in accordance with claim 9 wherein said at least one battery is mounted to a battery holder, said battery holder and associated battery located in said interior space when said device is in operation.

15. The device in accordance with claim 9 wherein said processor is configured to transmit secondary information stored in said second memory via said wireless communication in response to a particular input.

16. The device in accordance with claim 15 wherein said input is received from a remote device.

17. A method of transmitting and storing information comprising:
loading a primary data set to a portable data device;
storing said primary data set in a first data location of said device;
reading said primary data set at said device;
sending one or more times said primary data set from said device to at least one remote device;
receiving one or more times a second data set from at least one remote device;
storing each received second data set in a second data location of said device; and
retrieving said second data sets from said second data location of said device and providing said second data sets to at least one remote device.

18. The method in accordance with claim 17 wherein said step of loading is initiated by receiving a first input from a selector of said portable device, and said step of sending is initiated by receiving a second input from a selector of said portable device.

19. The method in accordance with claim 17 including the step of displaying information regarding an outcome of an operation of said device with an indicator.

20. The method in accordance with claim 19 wherein said indicator comprises a light.
